(19) United States
(12) Patent Application Publication
(10) Pub. No.: US 2012/0328754 A1
(43) Pub. Date: Dec. 27, 2012

(54) Impact-Modified Polypropylene Composite

(75) Inventors: John R. Campanelli, Greer, SC (US); Michael L. Becraft, Greer, SC (US)

(73) Assignee: CRYOVAC, INC., Duncan, SC (US)

(21) Appl. No.: 13/165,163

(22) Filed: Jun. 21, 2011

(51) Int. Cl. C08L 23/14; B65D 85/00; C08K 3/34; B82Y 30/00

(52) U.S. Cl. 426/531; 524/445; 977/700; 977/902

(57) ABSTRACT

An impact-modified polypropylene composite is made by mixing from 65 to 97 weight parts polypropylene having a glass transition temperature of greater than −25° C., from 3 to 35 weight parts propylene-based elastomer having a density of from 0.860 g/cc to 0.875 g/cc, a melting point of from 130° C. to 170° C., a glass transition temperature of from −35° C. to −25° C., and a melt flow rate of from 3.0 to 15.0 g/10 minutes, and from 0.1 to 20 weight parts of exfoliated silicate platelets.

### BACKGROUND

Embodiments of the present invention relate to impact-modified polypropylene incorporating exfoliated clay particles.

Composites of exfoliated clay particles dispersed in polypropylene can increase the modulus (e.g., stiffness) relative to unfilled semi-crystalline polypropylene. However, the brittleness of such composites tends to increase, and the impact strength tends to decrease, with particularly significant decrease at relatively cold temperatures approaching the glass transition temperature of the polypropylene medium.

Elastomeric impact modifiers may be incorporated into polypropylene to improve the impact strength performance by providing relatively “soft” domains to dissipate impact energy. However, incorporation of impact modifier tends to reduce the modulus of the resulting blend relative the unmodified polypropylene. If exfoliated clay particles are incorporated into traditionally impact-modified polypropylene, it is believed that the exfoliated clay particles tend to partition preferentially into the more compatible elastomeric impact modifier domains, which reduces the ability of the particles to enhance modulus.

### SUMMARY

One or more embodiments of the present invention may address one or more of the aforementioned problems.

In an embodiment, a composite is made by mixing:
from 65 to 97 weight parts polypropylene having a glass transition temperature of greater than −25° C. and comprising one or more polymers selected from propylene homopolymer and co-polypropylene;
from 3 to 35 weight parts propylene-based elastomer having a density of from 0.860 g/cc to 0.875 g/cc, a melting point of from 130° C. to 170° C., a glass transition temperature of from −35° C. to −25° C., and a melt flow rate of from 3.0 to 15.0 g/10 minutes, wherein the propylene-based elastomer comprises ethylene/propylene/1-butene copolymer having a propylene monomer content of from 55 to 90 mole %, an ethylene monomer content of from 4 to 25 mole %, and a 1-butene monomer content of from 10 to 25 mole %; and
from 0.1 to 20 weight parts of exfoliated silicate platelets having an average size of less than 90 nm in at least one direction, wherein the total weight of the polypropylene, the propylene-based elastomer, and the exfoliated silicate platelets is 100 weight parts.

These and other objects, advantages, and features of various embodiments of the invention will be more readily understood and appreciated by reference to the detailed description.

### DETAILED DESCRIPTION

Various embodiments of the present invention are directed to composites comprising polypropylene, propylene-based elastomer, and exfoliated silicate platelets, as described herein.

### Polypropylene

The composite of the one or more embodiments may comprise from 65 to 97 weight parts of polypropylene, for example, polypropylene comprising at least 90 mole % propylene monomer content and from 0 to 10 mole % of monomer content selected from ethylene monomer content and any of C4 to C10 alpha-olefin monomer content. As used herein, the propylene monomer content of a polymer refers to the amount of mer units of the polymer derived from, or corresponding to, propylene. Likewise, ethylene monomer content of a polymer refers to the amount of mer units of the polymer derived from, or corresponding to, ethylene, and so on for the other references to monomer content of a polymer.

The composite may comprise any of the polypropylenes described in his section, and combinations thereof, in at least any of 65, 70, 75, 80, 85, 90, and 95 weight parts, and/or at most any of 97, 95, 90, 85, 80, 75, and 70 weight parts, and ranges between any of these amounts (e.g., from 70 to 95 weight parts). Unless specified otherwise, “weight parts” as used herein is based on the total weight of the recited polypropylene, the recited propylene-based elastomer, and the recited exfoliated silicate particles herein in the composite equaling 100 weight parts.

The polypropylene may be a homopolymer polypropylene. The homopolypropylene may be selected from one or more of any of the isotactic form, syndiotactic form, or atactic form, or combinations thereof.

The polypropylene may comprise a co-polypropylene comprising (in addition to propylene monomer content) monomer content selected from ethylene monomer content and any of C₄ to C₁₀ alpha-olefin monomer content. For example, the co-polypropylene may comprise at least any of 0.1, 0.5, 1, 1.5, 2, 3, 4, and 5 mole % monomer content, and/or at most 10, 9.5, 9, 8, and 7 mole % monomer content, and any range between any of this amounts, of any of ethylene monomer content and/or any of C₄ to C₁₀ alpha-olefin monomer content, and combinations thereof. The co-polypropylene may comprise random co-polypropylene and/or block co-polypropylene. As used herein, “copolymer” (e.g., co-polypropylene) means a polymer derived from two or more types of monomers, and includes terpolymers, etc., such that “co-polypropylene” may include propylene polymer having more than two types of monomer content.

The polypropylene may have a glass transition temperature of greater than any of the following: −25° C., −20° C., −15° C., −10° C., −5° C., 0° C., 5° C., and 10° C.; and/or at most any of the following: −20° C., −15° C., −10° C., −5° C., 0° C., 5° C., 10° C., 15° C., and 20° C. All references to the glass transition temperature of a polymer in this application refer to the characteristic temperature at which glassy or amorphous polymers become flexible as determined by differential scanning calorimetry (DSC) according to ASTM D 3418.

The polypropylene may have a melting point of at least any of 160° C. and 165° C.; and/or at most any of 170° C. and 175° C. The polypropylene may have a density of at least any of 0.890, 0.895, 0.900, 0.905 g/cc; and/or at most any of 0.910, 0.905, 0.900, and 0.985 g/cc.

Exemplary polypropylene homopolymers useful in the various embodiments of the present invention include those sold by:
SCG Chemicals Co., Ltd., under the EL-Pro™ P400S trade name (density 0.910 g/cc and Tm 163° C.);
Flint Hills Resources, LP under the FHR Polypropylene P4G2K-152A (density 0.900 g/cc), FHR Polypropylene P4G3Z-050, and FHR Polypropylene P4G3Z-050F trade names;
Formosa Plastics Corporation, U.S.A. under the Formolene® 1102L (density 0.900 g/cc), Formolene® 1103k, Formolene® 4142K, Formolene® 5143C, Formolene® 5143H, and Formolene® 5181K trade names;
Haldia Petrochemicals Ltd. under the Halene P F103 (density 0.900 glee), Halene P R103, and Halene P T103 trade names;
Hipol A.D. under the Hipolen P® FB 4T (density 0.910 g/cc) and Hipolen P® FL 6C trade names;
Mitsui Chemicals, Inc. under the Hipol™ F401 (density 0.910 g/cc) and Hipol™ F601 trade names;
Jam Polypropylene Company under the Jampilen ADXP680, and Jampilen HP532J;
Reliance Industries Limited under the Koylene ADL ASO30NS, Koylene S3030, Koylene SS30NS, and Koylene SS35N trade names;
Oman Polypropylene LLC under the LUBAN™ 1104 H trade name;
M. Holland Company under the PP204 and PP210 trade names;
Phillips Sumika Polypropylene Company under the Marlex® PP HNZ-020 trade name;
LyondellBasell Industries under the Moplen HP450J (density 0.900 glee) and Pro-fax HP640H (density 0.905 g/cc) trade names;
Nizhnekamskneftekhim Inc. under the Neftekhim PP 1500H (S30G), Neftekhim PP 1500J (T30G), Neftekhim PP 1500K, Neftekhim PP 1502H (S30S), Neftekhim PP 1532J (T50G), Neftekhim PP 2641J (T31SE), Neftekhim PP 2642J, and Neftekhim PP 2648J trade names;
Osterman & Company under the Osterlene® PPH-3-0.75 trade name;
Pinnacle Polymers under the Pinnacle PP 1508 trade name (density 0.900 glee);
Samsung Total Petrochemicals Co., Ltd. under the Samsung Total HY200, Samsung Total HY300, Samsung Total HY301, and Samsung Total HY311 trade names;
LG Chem Ltd. under the Seetec PP H7411 trade name;
Titan Group under the Titanpro® 6423, Titanpro® 6431, Titanpro® 6531M, Titanpro® PD855, and Titanpro® PD859 trade names; and
Total Petrochemicals USA, Inc. under the 3270, 3271, 3276 (Tm 163° C. and density 0.905), 3363 (Tm 166° C. and density 0.905 g/cc), 3371 (Tm 325° F. and density 0.905 g/cc) , and 3761 trade names.

### Propylene-Based Elastomer

The composite of the one or more embodiments may comprise from 3 to 35 weight parts of propylene-based elastomer having a density from 0.860 g/cc to 0.875 g/cc, a melting point of from 130° C. to 170° C., and a glass transition temperature of from −35° C. to −25° C.

The composite may comprise the propylene-based elastomer in at least any of the following amounts: 3, 5, 7, 10, 12, 15, 20, 23, 25, 30, and 32 weight parts; and/or in at most any of the following amounts: 35, 32, 30, 27, 25, 23, 20, 18, 15, 12, 10, and 5 weight parts; and combinations thereof. As mentioned above, unless specified otherwise, “weight parts” as used herein is based on the total weight of the recited polypropylene, the recited propylene-based elastomer, and the recited exfoliated silicate particles herein in the composite equaling 100 weight parts.

The propylene-based elastomer of the composite may have a density of at least any of the following: 0.860, 0.862, 0.865, 0.870, and 0.872 g/cc; and/or at most any of the following: 0.875, 0.872, 0.870, 0.867, 0.863 g/cc; and combinations thereof. All references to the density of a polymer in this application are determined according to ASTM D1505.

The propylene-based elastomer of the composite may have a melting point of at least any of the following: 130, 135, 140, 145, 150, 155, 160, and 165° C.; and/or at most any of the following 170, 165, 160, 155, 150, 155, 150, 145, 140, and 135° C., and combinations thereof. All references to the melting point of a polymer in this application refer to the melting peak temperature of the dominant melting phase of the polymer as determined by differential scanning calorimetry (DSC) according to ASTM D-3418.

The propylene-based elastomer of the composite may have a glass transition temperature of at least any of the following: −35, −32, −30, −28, and −27° C.; and/or at most any of the following: −25, −27, −28, −30, −32, and −33° C.; and combinations thereof.

The propylene-based elastomer of the composite may have a melt flow rate (MFR) of at least any of the following: 3.0, 3.5, 4.0, 4.5, 5.0, 5.5, 6.0, 6.5, and 7.0 g/10 minutes; and/or at most any of the following: 15.0, 14.0, 13.0, 12.0, 11.0, 10.0, 9.5, 9.0, and 8.5 g/10 minutes; and combinations thereof. All references to the melt flow rate of a polymer in this application refer to the melt flow rate taken at 230° C. under a load of 2.16 kg, unless specified otherwise, measured according to ASTM D-1238 (Condition 230/2.16; Procedure B).

The propylene-based elastomer of the composite may comprise ethylene/propylene/1-butene copolymer having a propylene monomer content of from 55 to 90 mole %, an ethylene monomer content of from 4 to 25 mole %, and a 1-butene monomer content of from 10 to 25 mole %, based on the total monomer content of the copolymer. The ethylene/propylene/1-butene copolymer may have a propylene monomer content of at least any of 55, 58, 60, 62, and 65 mole %; and/or at most any of 90, 85, 83, 80, 78, and 75 mole %; an ethylene monomer content of at least any of 4, 6, 8, 10, 12, 14, 16, 18, and 20 mole %; and/or at most any of 25, 23, 20, 18, 17, 15, 10, and 8 mole %; and a 1-butene monomer content of at least any of 10, 12, 15, 18, 20, and 22 mole %; and/or at most any of 25, 23, 20, 18, 15, and 12 mole %; and combinations thereof, based on the total monomer content of the copolymer.

The propylene-based elastomer may comprise ethylene/propylene/1-butene terpolymer having monomer content consisting essentially of, or consisting of, propylene monomer content, ethylene monomer content, and 1-butene monomer content, such that there may not be any other unlisted monomer content.

Exemplary propylene-based elastomer consisting of ethylene/propylene/1-butene copolymer is commercially available from Mitsui Chemicals, Inc. under the Notio trade name and the PN-2060, PN-2070, and PN3560 product designation numbers. The Notio propylene-based elastomers are polymerized using metallocene catalyst, and may be characterized as having crystalline block portions and amorphous chain portions inserted into the crystalline block portions to yield very small crystalline domains.

Notio PN-2070 propylene-based elastomer is an ethylene/propylene/1-butene terpolymer believed to have a propylene monomer content reported as 71 mole %, has been measured as having propylene/ethylene/butene monomer contents of approximately 67 mole %/22 mole %/and 11 mole %, respectively, and has reported physical properties of a melting point of 138° C., a density of 0.867 g/cc, a glass transition temperature of −29° C., and a melt flow rate of 7.0 g/10 min.

Notio PN-2060 propylene-based elastomer is an ethylene/propylene/1-butene terpolymer believed to have a propylene monomer content reported as 79 mole %, has been measured as having propylene/ethylene/butene monomer contents of approximately 82 mole %/5 mole %/and 13 mole %, respectively, and has reported physical properties of a melting point of 155° C., a density of 0.868 g/cc, a glass transition temperature of −28° C., and a melt flow rate of 6.0 g/10 min.

Notio PN-3560 propylene-based elastomer is an ethylene/propylene/1-butene terpolymer that has been measured as having propylene/ethylene/butene monomer contents of approximately 72 mole %/14 mole %/and 14 mole %, respectively, and believed to have physical properties of a melting point of 158° C., a density of 0.866 g/cc, and a melt flow rate of 6 g/10 min.

Useful polypropylene-based elastomer may be manufactured, for example, by one or more of the methods set forth in U.S. Patent Application Publication 2008/0023215 A1 and U.S. Pat. No. 7,488,789 B2, each of which is incorporated herein in its entirety by this reference.

### Exfoliated Silicate Platelets

The composite of the one or more embodiments may comprise from 0.1 to 20 weight parts of exfoliated silicate platelets having an average size of less than 90 nm in at least one direction. The exfoliated silicate platelets may be derived from intercalated layered silicate, as described herein.

The exfoliated silicate platelets may have an average aspect ratio (i.e., the ratio of the average largest dimension to the average smallest dimension of the platelets) of from 10 to 30,000. Typically, the aspect ratio for the silicate platelets exfoliated from an intercalated layered silicate may be taken as the length (largest dimension) to the thickness (smallest dimension) of the platelets.

Useful aspect ratios for the exfoliated silicate platelets include at least any of the following values: 10; 20; 25; 200; 250; 1,000; 2,000; 3,000; and 5,000; and/or at most any of the following values: 25,000; 20,000; 15,000; 10,000; 5,000; 3,000; 2,000; 1,000; 250; 200; 25; and 20. The exfoliated silicate platelets may have an average size in the shortest dimension of at least any of the following values: 0.5 nm, 0.8 nm, 1 nm, 2, nm, 3 nm, 4 nm, and 5 nm; and/or at most any of the following values: 90 nm, 60 nm, 30 nm, 20 nm, 10 nm, 8 nm, 5 nm, and 3 nm, as estimated from transmission electron microscope (“TEM”) images. The exfoliated silicate platelets may have an average dimension small enough to maintain optical transparency of the composite in which the particles are dispersed.

The amount of exfoliated silicate platelets in the composite may be at least any of the following values 0.1, 0.5, 1, 1.5, 2, 2.5, 3, 4, 5, and 10 weight parts; and/or may be at most any of the following values: 20, 15, 10, 8, 6, 5, 4, 3, 2, and 1 weight parts. The weight of the exfoliated silicate platelets includes intercalating agent that may be sorbed to the silicate platelets. Exemplary intercalating agents are discussed herein.

It is believed that the exfoliated silicate platelets result when individual silicate layers of a layered silicate are no longer close enough to interact significantly with the adjacent layers via ionic, electrostatic, or van der Waals attractions or to form strongly correlated systems due to the large aspect ratios of the platelets. An exfoliated layered silicate has lost its registry and may be relatively uniformly and randomly dispersed in a medium. It is believed that the dispersion in a medium occurs when the interlayer spacing of the layered silicate is at or greater than the average radius of gyration of the molecules comprising the medium.

### Other Components

The composite of the one or more embodiments may comprise other components such as compatibilizer (e.g., dispersing aids) as discussed herein. Such compatiblizers may be used to enhance exfoliation of the intercalated layered silicate in the composite. Useful compatibilzers include polymers modified (e.g., grafted or copolymerized) with unsaturated carboxylic acid anhydride (i.e., anhydride-modified polymer) to incorporate anhydride functionality, which promotes or enhances the adhesion characteristics of the polymer. Examples of unsaturated carboxylic acid anhydrides include maleic anhydride, fumaric anhydride, and unsaturated fused ring carboxylic acid anhydrides (e.g., as described in U.S. Pat. No. 4,087,588, which is incorporated herein in its entirety by reference). Examples of anhydride-modified polymers include the anhydride-modified version of polyolefins such as polypropylene (e.g., propylene homo- and co-polymers), for example, maleic anhydride grafted polypropylene available from DuPont under the FUSABOND M613 trade name. Useful anhydride-modified polymers may contain anhydride moiety in an amount (based on the weight of the modified polymer) of at least any of the following: 0.1%, 0.5%, 1%, and 2%; and at most any of the following: 10%, 7.5%, 5%, and 4%.

Other useful additives include those known in the art of plastics, such as antiblock agents, antioxidant agents, antislip agents, slip agents, stabilizer agents, colorant agents, mold release agents, and pigments.

### Intercalated Layered Silicate

The exfoliated silicate platelets of the composite may be derived from a layered silicate (i.e., phyllosilicate) that may be naturally occurring or synthetically made. Exemplary layered silicates include:
1. Natural clays such as smectite clays, for example, bentonite clays (e.g., montmorillonite, hectorite), mica, vermiculite, nontronite, beidellite, volkonskoite, and saponite;
2. Layered polysilicates (e.g., layered silicic acid), such as kanemite, makatite, ilerite, octosilicate, magadiite, and kenyaite; and
3. Synthetic clays, such as, synthetic silicates, synthetic mica, synthetic saponite, synthetic laponite, synthetic hectorite, and synthetic hydrotalcites.

Layered silicates comprise a plurality of silicate layers, that is, a laminar structure having a plurality of stacked silicate sheets or layers with a variable interlayer distance between the layers. The average thickness of the silicate layers may be at least any of the following: 3, 5, 8, 10, 15, 20, 30, 40, and 50 Å; and/or at most any of the following: 60, 50, 45, 35, 25, 20, 15, 12, 10, 8, and 5 Å. For example, many layered silicates have a silicate layer thickness ranging from 8 to 11 Å. The average interlayer spacing of the layered silicate at 60% relative humidity before intercalation with an intercalating agent may be at least any of the following: 1, 2, 3, 4, 5, 6, 8, and 10 Å; and/or may be at most any of the following: 20, 15, 10, 8, 6, 5, 3, and 2 Å. The average interlayer spacing (i.e., the gallery spacing) of a layered silicate (including an intercalated layered silicate) refers to the distance between the internal faces of the non-exfoliated, adjacent layers of representative samples of the layered silicate. The interlayer spacing may be calculated using standard powder wide angle X-ray diffraction techniques generally accepted in the art in combination with Bragg's law equation, as is known in the art.

Useful layered silicates are available from various companies including, for example, Nanocor, Inc., Southern Clay Products, Kunimine Industries, Ltd., Elementis Pigments, and Rheox.

To enhance the ability to exfoliate the layered silicate to render exfoliated silicate platelets as described herein, the layered silicate may be intercalated with intercalating agent, which is sorbed between the silicate layers in an amount effective to provide an intercalated layered silicate having an expanded average interlayer spacing between the silicate layers, for example, an average interlayer spacing for the intercalated layered silicate of at least 20 Å. Thus, an intercalated layered silicate comprises intercalating agent sorbed between the silicate layers of the layered silicate. The term “sorbed” in this context means inclusion within the layered silicate (for example, by adsorption and/or absorption) without covalent bonding. An intercalating agent that is sorbed between silicate layers may be held to the interlayer surface of a silicate layer by one or more of ionic complexing, electrostatic complexing, chelation, hydrogen bonding, ion-dipole interaction, dipole-dipole interaction, and van der Waals forces.

Useful intercalating agents may comprise onium functionality, or may be free of onium functionality, such that the intercalated layered silicate may be essentially free of intercalating agent comprising onium functionality (for example, to comply with food packaging laws or regulations restricting food contact with certain agents).

Useful intercalating agents having onium functionality for use in intercalating the layered silicate and deriving the exfoliated silicate platelets as described herein may include those selected from one or more of the following types of compounds:
1) ammonium compounds (e.g., quaternary ammonium compounds, tertiary ammonium compounds, secondary ammonium compounds, primary ammonium compounds), such as any of the following types: alkyl ammonium compounds, such as tetramethyl ammonium compounds, hexyl ammonium compounds, butyl ammonium compounds, bis(2-hydroxyethyl) dimethyl ammonium compounds, bis(2-hydroxyethyl) octadecyl methyl ammonium compounds, octadecyl trimethyl ammonium compounds, octadecyl benzyl dimethyl ammonium compounds, hexyl benzyl dimethyl ammonium compounds, benzyl trimethyl ammonium compounds, butyl benzyl dimethyl ammonium compounds, tetrabutyl ammonium compounds, dodecyl ammonium compounds, di(2-hydroxyethyl) ammonium compounds, and polyalkoxylated ammonium compounds;
2) phosponium compounds (e.g., quaternary phosponium compounds, tertiary phosponium compounds, secondary phosponium compounds, primary phosponium compounds), such as any of the following types: alkyl phosphonium compounds, such as tetrabutyl phosphonium compounds, trioctyl octadecyl phosphonium compounds, tetraoctyl phosphonium compounds, octadecyl triphenyl phosphonium compounds; and
3) arsonium compounds, stibonium compounds, oxonium compounds, and sulfonium compounds.

The intercalated layered silicate (and/or the composite of one or more embodiments herein) may be essentially free of intercalating agent comprising onium functionality, for example, essentially free from a compound selected from any or all of the onium compounds identified herein (for example, to comply with food packaging laws or regulations restricting food contact with certain agents).

Useful intercalating agents that do not comprise onium functionality for use in intercalating the layered silicate and deriving the exfoliated silicate platelets as described herein may include:
1) intercalating agents such as fatty acid esters of pentaerythritol (i.e., fatty acid esters of 2,2-bis-hydroxymethyl-1,3-propanediol) and other variants, as disclosed in U.S. Patent Application Publication 2010-0040653 A1 published 18 Feb. 2010 to Becraft et al (Attorney Docket D43637), which is incorporated herein in its entirety by reference, for example, any of:
   a) pentaerythritol monostearate (“PEMS”), pentaerythritol distearate, pentaerythritol tristearate, pentaerythritol monobehenate, pentaerythritol dibehenate, pentaerythritol tribehenate, pentaerythritol monooleate, pentaerythritol dioleate, pentaerythritol trioleate, pentaerythritol ricinoleate, pentaerythritol monolaurate, pentaerythritol dilaurate, pentaerythritol trilaurate, pentaerythityl stearol (i.e., 2-(hydroxymethyl)-2-[(octadecyloxy)methyl]-1,3-propanediol); 2-(hydroxymethyl)-2-[(4-cyclohexane-butyrate)methyl]-1,3-propanediol; and 2-(hydroxymethyl)-2-[(4-phenylbutyrate)methyl]-1,3-propanediol;
   b) 1-hydroxy-2,2-bis(hydroxymethyl)octadecane; 1-hydroxy-2,2-bis(hydroxymethyl)tetradecane; and 1-hydroxy-2,2-bis(hydroxymethyl)dodecane;
   c) 2-(hydroxymethyl)-2-[(octadecylamino)methyl]-1,3-propanediol and N-tris(hydroxymethyl)methyl stearamide;
   d) 2-(hydroxymethyl)-2-[(octadecylthio)methyl]-1,3-propanediol; and
   e) 2-(hydroxymethyl)-2-[(14-hydroxy-3,6,9,12-tetraoxadeacanoyl)methyl]-1,3-propandiol;
   f) steroyl citric acid, 2-(octadecanoxy)-1,2,3-propanetricaboxylic acid, 2-(4-phenylbutanoxy)-1,2,3-propanetricaboxylic acid, and stearyl citrate;
2) intercalating agents such as lecithin, hydrogenated lecithin, and other variants, such as those disclosed in U.S. Patent Application Publication 2009-0297675 A1 published 3 Dec. 2009 to Grah et al (Attorney Docket D43930-01), which is incorporated herein in its entirety by reference;
3) intercalating agents such as those disclosed in U.S. Patent Application 2009-0297568-A1 published 3 Dec. 2009 to Grah et al (Attorney Docket D43950), which is incorporated herein in its entirety by reference, for example:
   a) Fatty acid esters of sorbitan, for example, sorbitan monostearate, sorbitan tristearate, sorbitan monolaurate, sorbitan monopalmitate, sorbitan monooleate, and sorbitan trioleate; such fatty acid esters of sorbitan are available, for example, from Uniquema Corporation (New Castle, Del.) under the SPAN 20, SPAN 40, and SPAN 60 trade names;
   b) Ethoxylated fatty esters of sorbitan, for example, ethoxylated sorbitan monostearate, ethoxylated sorbitan monolaurate, ethoxylated sorbitan monooleate, and ethoxylated sorbitan monopalmitate; such ethoxylated fatty esters of sorbitan are available, for example, from Uniquema Corporation (New Castle, Del.) under the Tween 20, Tween 40, and Tween 60 trade names;
   c) Fatty acid esters of glycerol, for example, glycerol monostearate, glycerol distearate, glycerol palmitate, glycerol oleate, glycerol dioleate, glycerol dipalmitate, glycerol monolaurate, glycerol dilaurate, glycerol monornyristate, glycerol monobehenate, glycerol monohydroxystearate, glycerol dihydroxystearate, glycerol monoricinoleate, and glycerol diricinoleate; and fatty acid esters of polyglycerol, for example, polyglycerol-3 stearate, polyglycerol-6 stearate, and polyglycerol-10 stearate; such fatty acid esters of glycerol and fatty acid esters of polyglycerol are available, for example, from Akzo Nobel Polymer Chemicals Company (Chicago, Ill.) under the Armostat 1000 trade name and from Lonza Inc. (Allendale, N.J.) under the Glycolube 180 trade name;
   d) Fatty acid amide waxes, for example, lauric diethanol amide, myristic diethanol amide, oleic diethanol amide, palmitic diethanol amide, stearic diethanol amide, and behenic diethanol amide; such fatty acid amide waxes are available, for example, from Chemax Performance Products, a division of Rutgers Organics Corporation (State College, Pa.), under the Chemstat LD-100 and the Chemid ODA 100 trade names, and from Akzo Nobel Polymer Chemicals Company (Chicago, Ill.) under the Armostat 2000 trade name;
   e) Variants of amide waxes, for example, N,N′ ethylene bis-stearamide, ethylene bis-oleamide, N-(2-hydroxyethyl)-12-hydroxystearamide, and N,N′-ethylene-bis(12-hydroxystearamide); such amide wax variants are available, for example, from Crompton Corporation (Middlebury, Conn.) under the Kemamide W-20 and Kemamide W-40 trade names; and
   f) Variants of amides, for example, oleyl palmityl amide, stearyl erucamide, and stearyl stearamide; such amide variants are available, for example, from Crompton Corporation (Middlebury, Conn.) under the Kemamide P-181 trade name and from Croda Inc. (Arlington, Tex.) under the Crodamide 212 trade name.

Additional useful intercalating agents are disclosed in U.S. Pat. No. 5,760,121 issued 2 Jun. 1998 to Beall et al, which is incorporated herein in its entirety by reference.

The amount of intercalating agent sorbed in the intercalated layered silicate per 100 weight parts layered silicate may be at least and/or at most any of the following: 5, 10, 20, 30, 50, 70, 90, 110, 150, 200, and 300 weight parts. The average interlayer spacing between the silicate layers of the intercalated layered silicate may be at least any of the following: 20, 30, 40, 50, 60, 70, 80, and 90 Å; and/or may be at most any of the following: 100, 90, 80, 70, 60, 50, 40, 30, 25 Å. The amount of the intercalating agent sorbed between the silicate layers may be effective to provide any of the forgoing average interlayer spacing between the silicate layers. The measurement of the average interlayer spacing of the intercalated layered silicate may be made at a relative humidity of 60%.

Exemplary intercalated layered silicates are commercially available, for example, from Southern Clay Products under the Cloisite 20A trade name, which is a montmorillonite layered silicate intercalated with dimethyl didehydrogenated tallow quaternary ammonium; from AkzoNobel under the Perkalite trade name, which are modified hydrotalcites organically modified with, for example, fatty acid (e.g., Perkalite F100 and F100S); and from Nanocor, Inc. under the Nanomer trade name.

### Manufacture of the Intercalated Layered Silicate

The intercalated layered silicate used in making embodiments of the composite may be commercially procured, or may be manufactured. To make an intercalated layered silicate, a layered silicate is mixed with the intercalating agent to effect the inclusion (i.e., sorption) of the intercalating agent in the interlayer space between the silicate layers of the layered silicate. In doing so, the resulting intercalated layered silicate may be rendered organophilic (i.e., hydrophobic) and show an enhanced attraction to an organic medium. The inclusion of the intercalating agent within the interlayer spaces between the silicate layers of the layered silicate increases the interlayer spacing between adjacent silicate layers. This may disrupt the tactoid structure of the layered silicate to enhance the dispersibility of the intercalated layered silicate in a medium.

Methods of making intercalated layered silicates are known in the art, for example, see U.S. Patent Application Publication 2010-0040653 A1 published 18 Feb. 2010 to Becraft et al (Attorney Docket D43637), previously incorporated herein by reference.

The intercalated layered silicate may be further treated (or the layered silicate may be treated before intercalation to form the intercalated layered silicate) to aid dispersion and/or exfoliation in a medium and/or improve the strength of a resulting polymer/silicate interface. For example, the intercalated layered silicate (or the layered silicate before intercalation to form the intercalated layered silicate) may be treated with a surfactant or reactive species to enhance compatibility with the medium. With many layered silicates, the silicate layers terminate with surface silanol functionality. It may be desirable for greater compatibility with non-polar matrices to render these surfaces more hydrophobic. One method to achieve this is to modify the surface (e.g., react the functional groups present on the edges of the silicate layers) with an organosilane reagent (e.g., silane coupling agent) such as, n-octadecyldimethylchlorosilane, n-octadecyldimethylmethoxysilane, trimethylchlorosilane, hexamethyldisilazane, and the like.

The intercalated layered silicate may be further treated with a compatibilizer to aid dispersion, such as a wax, polyolefin oligomer, or polymer having polar groups. Exemplary compatibilizer waxes include polyethylene wax, oxidized polyethylene wax, polyethylene vinyl acetate wax, polyethylene acrylic acid wax, polypropylene wax, montan wax, carnauba wax, candelilla wax, beeswax, and maleated waxes. Examples of maleated wax include maleic anhydride modified olefin oligomer or polymer, and maleic anhydride modified ethylene vinyl acetate oligomer or polymer. An oligomer or polymer may be modified (e.g., grafted) with unsaturated carboxylic acid anhydride (i.e., anhydride-modified oligomer) to incorporate anhydride functionality, which promotes or enhances the adhesion characteristics of the oligomer or polymer (i.e., promotes or enhances the compatibility of the modified oligomer or polymer with the intercalated layered silicate). Examples of unsaturated carboxylic acid anhydrides include maleic anhydride, fumaric anhydride, and unsaturated fused ring carboxylic acid anhydrides. Anhydride-modified polymer may be made by grafting or copolymerization, as is known in the art. Useful anhydride-modified oligomers or polymers may contain anhydride group in an amount (based on the weight of the modified polymer) of at least any of the following: 0.1%, 0.5%, 1%, and 2%; and/or at most any of the following: 10%, 7.5%, 5%, and 4%.

The amount of compatibilizer present or used (e.g., any of one or more of any of the compatibilizers described herein) may be at least any of 10, 20, 30, 40, 60, 80, 100, and 120 weight parts; and/or at most any of 140, 120, 100, 80, 60, 40, and 20 weight parts either relative to 100 weight parts of intercalated layered silicate used in making the composite, or relative to 100 weight parts of exfoliated silicate platelets having an average size of less than 90 nm in at least one direction.

The composite may be substantially free of organosilane reagent (e.g., silane coupling agent), or substantially free of compatibilizers, such as one or more of any of those discussed above.

### Manufacture and Use of the Composite

Embodiments of the composite may be made by mixing the intercalated layered silicate with the medium of polypropylene, propylene-based elastomer, and optional other components to effect mixture of the components and exfoliation of the intercalated layered silicate into exfoliated silicate platelets within the composite. The composite may be made by known compounding methods, for example, by dry blending the individual components and subsequently melt mixing, either directly in an extruder used to make a finished article comprising the composite, or by pre-melt mixing in a separate extruder (e.g., a Banbury mixer, a Haake mixer, a Brabender internal mixer, a single-screw extruder, or a twin screw extruder) to form the composite.

A masterbatch of the intercalated layered silicate (i.e., “silicate masterbatch”) may be pre-made comprising the intercalated layered silicate mixed with one or more of the medium components (i.e., polypropylene, propylene-based elastomer, and/or other additives such as compatibilizer) to at least partially disperse and exfoliate the intercalated layered silicate into exfoliated silicate platelets. The silicate masterbatch may then be mixed with the remaining medium components of the composite to form the composite having the desired relative amounts of components, and to complete the remaining amount of exfoliation of the intercalated layered silicate, as needed.

The intercalated layered silicate (or the silicate masterbatch) may be mixed with the medium comprising polypropylene and propylene-based elastomer under conditions effective to exfoliate at least a portion of the intercalated layered silicate into exfoliated silicate platelets dispersed in the medium.

The effective conditions to exfoliate the intercalated layered silicate may include the addition of mixing and/or shearing energy to the mixture of the intercalated layered silicate and the medium comprising polypropylene and propylene-based elastomer. The process variables for exfoliating the intercalated layered silicate in the medium include time, temperature, geometry of the mixing apparatus, and the shear rate, and generally requires a balance of these variables, as is known to those of skill in the art. The balancing of these variables may take into account the desire to minimize the physical degradation or decomposition of the medium and/or the intercalating agent, for example, by limiting the upper temperature of the processing and/or the amount of time at a selected temperature during processing.

An increase in temperature generally provides more thermal energy to enhance exfoliation. A decrease in temperature may lower the viscosity of the mixture while increasing the shear rate. An increase in shear rate generally enhances exfoliation. Shear rates of at least any of the following may be applied to the mixture of the intercalated layered silicate in the medium: 1 sec⁻¹, 10 sec⁻¹, 50 sec¹, 100 sec⁻¹, and 300 sec⁻¹.

Illustrative methods or systems for applying shear to effect exfoliation of the intercalated layered silicate in the composite and to mix the components of the composite include mechanical methods for shearing a flowable mixture, such as the use of stirrers, blenders, Banbury type mixers, Brabender type mixers, long continuous mixers, injection molding machines, and extruders (single-screw and twin screw extruders).

The effective exfoliation conditions may comprise raising the temperature of the composite mixture, so that the mixture is thermally processible at a reasonable rate in the mechanical system either before, while, or after adding the intercalated layered silicate to composite mixture. During processing, the mixture of the intercalated layered silicate in the medium may be at a temperature, for example, of at least and/or at most any of the following temperatures: 150° C., 200° C., 240° C., 280° C., 300° C., 320° C., 350° C., 380° C., and 400° C. The amount of residence time that the mixture of the intercalated layered silicate and the other composite medium may reside at any of these temperatures may be at least and/or at most any of the following times: 2, 4, 5, 8, 10, 12, 15, and 20 minutes.

Thus, one or more embodiments of the composite may be made by mixing:
from 65 to 97 weight parts of polypropylene having a glass transition temperature of greater than −25° C. comprising one or more polymers selected from any of the propylene homopolymers and co-polypropylenes described herein, for example, at least any of 65, 70, 75, 80, 85, 90, and 95 weight parts, and/or at most any of 97, 95, 90, 85, 80, 75, and 70 weight parts;
from 3 to 35 weight parts, for example, at least any of 3, 5, 7, 10, 12, 15, 20, 23, 25, 30, and 32 weight parts; and/or at most any of 35, 32, 30, 27, 25, 23, 20, 18, 15, 12, 10, and 5 weight parts, of propylene-based elastomer having any combination of characteristics described herein relative the propylene-based elastomer, for example, a density of from 0.860 g/cc to 0.875 g/cc, a melting point of from 130° C. to 170° C., and a glass transition temperature of from −35° C. to −25° C., and a melt flow rate of from 3 to 15 g/10 minutes, wherein the propylene-based elastomer comprises ethylene/propylene/1-butene copolymer having a propylene monomer content of from 55 to 90 mole %, an ethylene monomer content of from 4 to 25 mole %, and a 1-butene monomer content of from 10 to 25 mole %;
from 0.1 to 20 weight parts exfoliated silicate particles having an average size of less than 90 nm in at least one direction, for example, at least any of 0.1, 0.5, 1, 1.5, 2, 2.5, 3, 4, 5, and 10 weight parts; and/or at most any of 20, 15, 10, 8, 6, 5, 4, 3, 2, and 1 weight parts, where the total weight of the polypropylene, the propylene-based elastomer, and the intercalated layered silicate is 100 weight parts; and
optionally compatibilizer as discussed herein.

The composition may have a modulus of at least any of 140,000; 160,000; and 180,000 psi; and/or at most 200,000 psi. As used herein, modulus measurements refers to the modulus of elasticity (Young's modulus) measured at 23° C. (73° F.) according to ASTM D882.

The composition may have an impact strength of at least any of 0.3, 0.4, 0.5, 0.7, and 0.8 joules; and/or at most 1.5 joules. As used herein, impact strength measurements refer to the energy to break the sample measured at 4.4° C. (40° F.) according to ASTM D3763 (Dynatup).

It is believed that the use of the propylene-based elastomer described herein as the impact modifier for the polypropylene medium of the composite results in a composite mixture that does not take on a structure in which relatively large domains or “islands” of the impact modifier are distributed within the polypropylene medium. Rather, it is believed that the impact modifier forms a “network” of helical crystals portions having a size in the range of 10 nm to 50 nm joining to amorphous regions of impact modifier, such that the resulting composite mixture provides for relatively small domains of the impact modifier distributed within the polypropylene medium. Although not being bound by this theory, it is believed that as a result of the above-described domain structures, the exfoliated silicate platelets distributed in the medium of propylene and propylene-based impact modifiers are hindered from preferentially residing in the small impact modifier domains, and accordingly, the exfoliate silicate platelets reside to a greater extent in the polypropylene dominated phases. By residing in the polypropylene dominated phases, the exfoliated silicate platelets can contribute to an increase in the modulus of the composite by enhancing the crystallinity of the polypropylene domains, as opposed to being preferentially incorporated in the impact modifier domains, where the exfoliated silicate platelets would have less of an effect on modulus enhancement.

Molding operations known in the art may be used to form useful fabricated articles or parts comprising one or more embodiments of the composite disclosed herein, such operations including injection molding, blow molding, and profile extrusion. Articles that may be formed comprising one or more embodiments of the composite disclosed herein include articles for packaging or storing food products (e.g., meats, beverages), including, for example, any of bottles, cups, tubs, trays, containers, and lids; articles for household or personal use, for example, toys; articles for use in automobiles, airplanes, or other vehicles; machinery, including housings for mechanical equipment such as lawn mowers; furniture such as outdoor furniture (e.g., lawn furniture); outdoor equipment such as shovels (e.g., snow shovels).

A package may comprise the composite disclosed herein, for example, a packaged food having a food product packaged within the package comprising the composite. Such a package may provide enhanced modulus performance as well as enhanced impact strength even at lower temperatures, for example, at refrigeration temperatures of from 0° C. to 5° C. commonly found in refrigerators, and also at freezer temperatures of at most 0° C., where the packaged food may be stored so that the package comprising the composite has a temperature of at most 0° C. and the food product is “frozen.”

### EXAMPLES

The following examples are presented for the purpose of further illustrating and explaining embodiments of the present invention and are not to be taken as limiting in any regard. Unless otherwise indicated, all parts and percentages are by weight.

In the examples and comparatives below, the following materials were used:
“IC-1” is an intercalated clay, namely, dimethyl didehydrogenated tallow quaternary ammonium intercalated montmorillonite available from Southern Clay Products under the CLOISITE 20A trade name. The concentration of the intercalating agent was 95 meq/100 g clay (i.e., approximately 30 weight % intercalant).
“PP-1” is polypropylene homopolymer available from ExxonMobil Corporation under the trade name grade PP4062E7, believed to have a density of 0.90 g/cc, a melt flow rate of 3.4 g/10 minutes (230° C., 2.16 kg), and a melting point of 163° C.
“Comp-1” is a compatibilizer consisting of maleic anhydride grafted polypropylene available from DuPont under the FUSABOND M613 trade name.
“Mod-1” is an impact modifier, namely, a propylene-based elastomer consisting of an ethylene/propylene/1-butene terpolymer available from Mitsui Chemicals Corporation under the Notio PN-2070 trade name, and having the physical properties described in the propylene-based elastomer section above.
“Mod-2” is an impact modifier, namely, amorphous ethylene/propene/1-butene copolymer (propene rich) believed to have a density of 0.87 g/cc, a glass transition temperature of −33° C. available from Evonik Industries (formerly Degussa) under the VESTOPLAST Grade 708 trade name. In reference to a polymer, “amorphous” means no significant melt peak shown by DSC; accordingly an amorphous polymer in essence lacks a melting point.
“Mod-3” is an impact modifier, namely, amorphous ethylene/propene/1-butene copolymer (propene rich) believed to have 6 wt. % ethylene monomer content, 66 wt. % propylene monomer content, and 28 wt. % 1-butene content, a glass transition temperature of −33° C., and a density of 0.87 g/cc available from Evonik Industries (formerly Degussa) under the VESTOPLAST Grade 750 trade name.
“Mod-4” is an impact modifier, namely, ethylene/propene/1-butene copolymer believed to have a glass transition temperature of from −32° C. to −33° C., a melting point of 104° C., and an MFR (2.16 kg, 140° C.) of 350 g/10 minutes available from Evonik Industries (formerly Degussa) under the VESTOPLAST EP X 01 trade name.
“Mod-5” is an impact modifier, namely, ethylene/propene/1-butene copolymer believed to have a glass transition temperature of −32° C., a melting point of 161° C., and an MFR (2.16 kg, 230° C.) of from 180 to 200 g/10 minutes available from Evonik Industries (formerly Degussa) under the VESTOPLAST EP X 22 trade name.
“Mod-6” is an impact modifier, namely, ethylene/propene/1-butene copolymer (propene rich) believed to have a glass transition temperature of from −33° C. to −32° C., a melting point of 161° C., and an MFR (2.16 kg, 230° C.) of 138 g/10 minutes available from Evonik Industries (formerly Degussa) under the VESTOPLAST EP X 35 trade name.

Each of the following masterbatches (MB 1 through MB 6) were made by mixing in a Haake internal mixer the following materials in the amounts shown in Table 1 below: intercalated clay (IC-1), compatiblizer (Comp-1), and each of the impact modifiers Mod-1 through Mod-8 as show in Table 1 below. Also, a masterbatch (MB7) was made by mixing the intercalated clay (IC-1), compatibilizer (Comp-1), and polypropylene (PP-1) in the amounts shown below. Each masterbatch was mixed for 5 minutes at 100 rpm, with an initial temperature varying between 160 and 180° C., depending on the melt index of the major resin.

TABLE 1

| | IC-1 | Comp-1 | Mod-1 | Mod-2 | Mod-3 | Mod-4 | Mod-5 | Mod-6 | PP-1 |
|---|---|---|---|---|---|---|---|---|---|
| | (wt. %) | (wt. %) | (wt. %) | (wt. %) | (wt. %) | (wt. %) | (wt. %) | (wt. %) | (wt. %) |
| MB1 | 20 | 20 | 60 | | | | | | |
| MB2 | 20 | 20 | | 60 | | | | | |
| MB3 | 20 | 20 | | | 60 | | | | |
| MB4 | 20 | 20 | | | | 60 | | | |
| MB5 | 20 | 20 | | | | | 60 | | |
| MB6 | 20 | 20 | | | | | | 60 | |
| MB7 | 20 | 20 | | | | | | | 60 |

Wt. % are based on the total weight of the masterbatch.

Example 1 was made as a 10 mil thick film as follows. The masterbatch MB1, polypropylene PP-1, and additional amount of the impact modifier Mod-1 were dry blended and added to the feed throat of a Haake single screw extruder Rheomex 252 equipped with a Maddox mixer (L/D=24) and four heat zones (150, 190, 200, and 200° C.). The resulting mixture was extruded through a 6-inch coat hanger die onto a chilled roll to produce a 10 mil nominal thickness film. The amount of combined masterbatch, impact modifier, and polypropylene were such to produce an Example 1 film having a composition of 2 wt. % IC-1, 2 wt. % Comp-1, 20 wt. % Mod-1, and 76 wt. % PP-1.

Examples 2 through 11 films were made as 10 mil nominal thickness films in a manner similar to that of Example 1 film, but using amounts of combined masterbatch (MB1), impact modifier (Mod-1), and polypropylene (PP-1) to produce Examples 2 through 11 films having the final compositions set forth in Table 2. Comparatives 1 through 10 were made as 10 mil nominal thickness films in a similar manner as Example 1 film, but using amounts of combined masterbatch (MB1 through MB7 of the corresponding type), and/or impact modifier (of the corresponding type), and/or polypropylene (PP-1) to produce Comparative Films 1-10 having the final compositions set forth in Table 2 below.

TABLE 2

| | Intercalated | | Impact | | Normalized | |
|---|---|---|---|---|---|---|
| | Clay | Compatibilizer | Modifier | Polypropylene | Impact | Normalized |
| | IC-1 (wt. %) | Comp-1 (wt. %) | (type/wt. %) | PP-1 (wt. %) | Strength* | Modulus** |
| Example 1 | 2 | 2 | Mod 1/20 | 76 | n/m | n/m |
| Example 2 | 2 | 2 | Mod 1/11 | 85 | 3.77 | 1.39 |
| Example 3 | 2.5 | 2.5 | Mod 1/11 | 84 | 1.54 | 1.16 |
| Example 4 | 3 | 3 | Mod 1/11 | 83 | 3.46 | 1.40 |
| Example 5 | 4 | 4 | Mod 1/11 | 81 | 1.92 | 1.52 |
| Example 6 | 5 | 5 | Mod 1/11 | 79 | 1.92 | 1.56 |
| Example 7 | 2.5 | 2.5 | Mod 1/5 | 90 | 1.38 | 1.71 |
| Example 8 | 2.5 | 2.5 | Mod 1/8 | 87 | 1.54 | 1.17 |
| Example 9 | 2.5 | 2.5 | Mod 1/14 | 81 | 2.54 | 1.06 |
| Example 10 | 2.5 | 2.5 | Mod 1/17 | 78 | 2.31 | 0.98 |
| Example 11 | 2.5 | 2.5 | Mod 1/20 | 75 | 4.08 | 1.11 |
| Comparative 1 | 2 | 2 | Mod 2/20 | 76 | 1.44 | 0.90 |
| Comparative 2 | 2 | 2 | Mod 3/20 | 76 | 1.37 | 1.01 |
| Comparative 3 | 2 | 2 | Mod 4/20 | 76 | 0.41 | 1.27 |
| Comparative 4 | 2 | 2 | Mod 5/20 | 76 | 1.22 | 0.90 |
| Comparative 5 | 2 | 2 | Mod 6/20 | 76 | 2.56 | 0.95 |
| Comparative 6 | 2 | 2 | — | 96 | 0.38 | 1.92 |
| Comparative 7 | — | — | Mod 1/20 | 80 | 11.77 | 0.5 |
| Comparative 8 | — | — | Mod 1/10 | 90 | 9.58 | 0.73 |
| Comparative 9 | — | — | — | 100 | 0.18 joules | 840 MPa |
| | | | | | (actual) | (actual) |
| | | | | | (0.13 ft · lb) | (122,000 psi) |
| Comparative 10 | — | — | — | 100 | 0.37 joules | 1140 MPa |
| | | | | | (actual) | (actual) |
| | | | | | (0.27 ft · lb) | (165,000 psi)) |

Wt. % are based on the total weight of the film;
“n/m” means this value was not measured.
*Impact strength is the energy to break the sample measured at 4.4° C. (40° F.) according to ASTM D3763 (Dynatup). Because the impact strength of polypropylene changes with aging time, the impact strength values for Examples 1-11 were normalized relative to 100% PP-1 by dividing the measured impact strength by the measured impact strength of Comparative 9 (0.18 joules), which is 100% PP-1 that had been aged for the same length of time as Examples 1-11. Similarly, the impact strength values for Comparatives 1-8 were normalized relative to 100% PP-1 by dividing the measured impact strength by the measured impact strength of Comparative 10 (0.37 joules), which is 100% PP-1 that had been aged for the same length of time as Comparatives 1-8.
**Modulus is the modulus of elasticity (Young's modulus) measured at 23° C. (73° F.) according to ASTM D882. Because the modulus of polypropylene changes with aging time, the modulus values for Examples 1-11 were normalized relative to 100% PP-1 by dividing the measured modulus by the measured modulus of Comparative 9 (840 MPa), which is 100% PP-1 that had been aged for the same length of time as Examples 1-11. Similarly, the modulus values for Comparatives 1-8 were normalized relative to 100% PP-1 by dividing the measured modulus by the measured modulus of Comparative 10 (1140 MPa), which is 100% PP-1 that had been aged for the same length of time as Comparatives 1-8.

Discussing the test results shown in Table 2, Comparative 8 sample having 10% impact modifier showed a 9.58 times increase in impact strength relative to pure polypropylene without impact modifier. The Comparative 7 sample having 20% impact modifier showed an 11.77 times increase in impact strength relative to pure polypropylene without impact modifier. As discussed in the Background section, it is expected that the use of impact modifier increases the impact strength.

Also for the Comparative 8 sample, the use of 10% impact modifier resulted in a modulus only 0.73 times the modulus of the pure polypropylene without impact modifier. The Comparative 7 sample having 20% impact modifier showed an even higher detriment to the modulus, having only 0.5 times the modulus of the pure polypropylene without impact modifier. As discussed in the Background section, it is expected that the use of impact modifier decreases the modulus.

The Comparative 6 sample having dispersed exfoliated clay particles showed a 1.92 times increase in modulus relative to pure polypropylene without dispersed exfoliated clay particles. However, the impact strength of the Comparative 6 sample was only 0.38 times that of the pure polypropylene sample without dispersed exfoliated clay particles. As discussed in the Background section, it is expected that the dispersion of exfoliated clay particles increases the modulus of polypropylene, yet decreases the impact strength.

The Comparative 1-5 samples having both impact modifier and dispersed exfoliated clay particles failed to show an improvement in both the impact strength and the modulus relative the pure polypropylene. Although the impact strength was enhanced for

Comparatives 1-2 and 4-5 (the normalized values were above 1), the corresponding modulus failed to be enhanced (i.e., the normalized values were at most 1.01). For Comparative 3, the impact strength decreased to 0.41 times that of pure polypropylene, although the modulus improved to 1.27 times that of pure polypropylene. Thus the Comparative 1-5 samples failed to show improvement in both impact strength and modulus.

The Example 2-11 samples had impact modifier and dispersed exfoliated clay particles in accordance with various embodiments of the present invention. In contrast to the Comparatives, the Examples 2-9 and 11 showed enhancement of both the impact strength and the modulus relative pure polypropylene. For example, Example 2 having 11% impact modifier and 2% dispersed exfoliated clay particles had an impact strength 3.77 times that of pure polypropylene and modulus 1.39 times that of pure polypropylene. Example 11 having 20% impact modifier and 2.5% dispersed exfoliated clay particles had an impact strength 4.08 times that of pure polypropylene and modulus 1.11 times that of pure polypropylene. Of the ten measured examples, only one (Example 10) failed to show an improvement in both properties; and even Example 10 had a improved impact strength 2.31 times that of pure polypropylene, but did not show improvement in modulus (0.98 times that of pure polypropylene).

Thus, the vast majority of the Examples showed significant improvements in both impact strength and modulus by the use of the propylene-based elastomer of the recited type as impact modifier for polypropylene in conjunction with exfoliated silicate particles in the manner as disclosed herein. This is a surprising and unexpectedly good result to one of skill in the art, as is seen by comparison to the results of the Comparative samples, as discussed above.

One or more embodiments of the present invention are set forth below in the following sentences A through W:

A. A composite made by mixing:
from 65 to 97 weight parts polypropylene having a glass transition temperature of greater than −25° C. and comprising one or more polymers selected from propylene homopolymer and co-polypropylene;
from 3 to 35 weight parts propylene-based elastomer having a density of from 0.860 g/cc to 0.875 g/cc, a melting point of from 130° C. to 170° C., a glass transition temperature of from −35° C. to −25° C., and a melt flow rate of from 3.0 to 15.0 g/10 minutes, wherein the propylene-based elastomer comprises ethylene/propylene/1-butene copolymer having a propylene monomer content of from 55 to 90 mole %, an ethylene monomer content of from 4 to 25 mole %, and a 1-butene monomer content of from 10 to 25 mole %; and
from 0.1 to 20 weight parts of exfoliated silicate platelets having an average size of less than 90 nm in at least one direction, wherein the total weight of the polypropylene, the propylene-based elastomer, and the exfoliated silicate platelets is 100 weight parts.
   B. The composite of sentence A wherein the propylene-based elastomer has a density of from at least any of the following: 0.860, 0.862, 0.865, 0.870, and 0.872 g/cc; and/or at most any of the following: 0.875, 0.872, 0.870, 0.867, 0.863 g/cc 0.865 to 0.870 g/cc.
   C. The composite of any one of the previous sentences wherein the propylene-based elastomer has a melting point of at least any of the following: 130, 135, 140, 145, 150, 155, 160, and 165° C.; and/or at most any of the following 170, 165, 160, 155, 150, 155, 150, 145, 140, and 135° C.
   D. The composite of any one of the previous sentences wherein the propylene-based elastomer has a propylene monomer content of at least any of 55, 58, 60, 62, and 65 mole %; and/or at most any of 90, 85, 83, 80, 78, and 75 mole %; and/or an ethylene monomer content of at least any of 4, 6, 8, 10, 12, 14, 16, 18, and 20 mole %; and/or at most any of 25, 23, 20, 18, 17, 15, 10, and 8 mole %; and/or a 1-butene monomer content of at least any of 10, 12, 15, 18, 20, and 22 mole %; and/or at most any of 25, 23, 20, 18, 15, and 12 mole %; and combinations thereof, based on the total monomer content of the propylene-based elastomer.
   E. The composite of any one of the previous sentences wherein the propylene-based elastomer has a melt flow rate of at least any of the following: 3.0, 3.5, 4.0, 4.5, 5.0, 5.5, 6.0, 6.5, and 7.0 g/10 minutes; and/or at most any of the following: 15.0, 14.0, 13.0, 12.0, 11.0, 10.0, 9.5, 9.0, and 8.5 g/10 minutes; and combinations thereof.
   F. The composite of any one of the previous sentences wherein the propylene-based elastomer has a glass transition temperature of at least any of the following: −35, −32, −30, −28, and −27° C.; and/or at most any of the following: −25, −27, −28, −30, −32, and −33° C.; and combinations thereof.
   G. The composite of any one of the previous sentences made by mixing from at least any of the following amounts: 3, 5, 7, 10, 12, 15, 20, 23, 25, 30, and 32 weight parts; and/or in at most any of the following amounts: 35, 32, 30, 27, 25, 23, 20, 18, 15, 12, 10, and 5 weight parts; and combinations thereof, of the propylene-based elastomer.
   H. The composite of any one of the previous sentences wherein the propylene-based elastomer consists of propylene monomer content, ethylene monomer content, and 1-butene monomer content.
   I. The composite of any one of the previous sentences comprising at least any of the following amounts 0.1, 0.5, 1, 1.5, 2, 2.5, 3, 4, 5, and 10 weight parts; and/or at most any of the following amounts: 20, 15, 10, 8, 6, 5, 4, 3, 2, and 1 weight parts of exfoliated silicate platelets having an average size of less than at least any of 90 nm, or 60 nm, or 30 nm in at least one direction.
   J. The composite of any one of the previous sentences comprising at least any of 10, 20, 30, 40, 60, 80, 100, and 120 weight parts; and/or at most any of 140, 120, 100, 80, 60, 40, and 20 weight parts of compatibilizer relative to 100 weight parts of exfoliated silicate platelets.
   K. The composite of any one of the previous sentences wherein the polypropylene is a homopolymer.
   L. The composite of any one of the sentences A through J wherein the polypropylene is a co-polypropylene.
   M. The composite of sentence L wherein the co-polypropylene comprises at least any of 0.1, 0.5, 1, 1.5, 2, 3, 4, and 5 mole % monomer content, and/or at most 10, 9.5, 9, 8, and 7 mole % monomer content, and any combination thereof, of any of ethylene monomer content and/or any of C₄ to C₁₀ alpha-olefin monomer content.
   N. The composite of any one the previous sentences wherein the polypropylene has a glass transition temperature of greater than any of the following: −25° C., −20° C., −15° C., −10° C., −5° C., 0° C., 5° C., and 10° C.; and/or at most any of the following: −20° C., −15° C., −10° C., −5° C., 0° C., 5° C., 10° C., 15° C., and 20° C.
   O. The composite of one the previous sentences made by mixing at least any of 65, 70, 75, 80, 85, 90, and 95 weight parts, and/or at most any of 97, 95, 90, 85, 80, 75, and 70 weight parts of the polypropylene.
   P. The composite of any one of the previous sentences wherein the composite is essentially free from intercalating agent comprising any one of the functionalities selected from any of onium functionality, ammonium functionality, phosponium functionality, and/or arsonium functionality.
   Q. The composite of any one of the previous sentences having an impact strength of at least any of 0.3, 0.4, 0.5, 0.7, and 0.8 joules; and/or at most 1.5 joules.
   R. The composite of any one of the previous sentences having a modulus of at least any of 140,000; 160,000; and 180,000 psi; and/or at most 200,000 psi.
   S. A packaged food comprising:
a package comprising the composite of any one of the previous sentences; and
a food product packaged within the package, wherein the package has a temperature of from 0° C. to 5° C. or at most 0° C.
   T. The packaged food of sentence S wherein the package comprises a tray comprising the composite of any one of the sentences A though R.
   U. A packaging article comprising the composite of any one of the sentences A through R, wherein the packaging article comprises one or more of any of bottles, cups, tubs, trays, containers, and lids.
   V. An article comprising the composite of any one of the sentences A through R, wherein the article is selected from one or more of any of toys, automobiles, airplanes, vehicles, housings for mechanical equipment, lawn mowers, furniture, outdoor furniture, lawn furniture, shovels, snow shovels.
   W. A molded article comprising the composite of any one of the sentences A through R.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

What is claimed is:

1. A composite made by mixing:
from 65 to 97 weight parts polypropylene having a glass transition temperature of greater than −25° C. and comprising one or more polymers selected from propylene homopolymer and co-polypropylene;
from 3 to 35 weight parts propylene-based elastomer having a density of from 0.860 g/cc to 0.875 g/cc, a melting point of from 130° C. to 170° C., a glass transition temperature of from −35° C. to −25° C., and a melt flow rate of from 3.0 to 15.0 g/10 minutes, wherein the propylene-based elastomer comprises ethylene/propylene/1-butene copolymer having a propylene monomer content of from 55 to 90 mole %, an ethylene monomer content of from 4 to 25 mole %, and a 1-butene monomer content of from 10 to 25 mole %; and
from 0.1 to 20 weight parts of exfoliated silicate platelets having an average size of less than 90 nm in at least one direction, wherein the total weight of the polypropylene, the propylene-based elastomer, and the exfoliated silicate platelets is 100 weight parts.

2. The composite of claim 1 wherein the propylene-based elastomer has a density of from 0.865 to 0.870 g/cc.

3. The composite of claim 1 wherein the propylene-based elastomer has a melting point of at least 135° C.

4. The composite of claim 1 wherein the propylene-based elastomer has a melting point of at most 160° C.

5. The composite of claim 1 wherein the propylene-based elastomer has a propylene monomer content of from 60 to 75 mole %.

6. The composite of claim 1 wherein the propylene-based elastomer has a melt flow rate at least 5.0 g/10 minutes.

7. The composite of claim 1 wherein the propylene-based elastomer has a melt flow rate of at most 8.0 g/10 minutes.

8. The composite of claim 1 wherein the propylene-based elastomer has a glass transition temperature of at least −30° C.

9. The composite of claim 1 made by mixing from 5 to 25 weight parts of the propylene-based elastomer.

10. The composite of claim 1 comprising from 0.5 to 10 weight parts of exfoliated silicate platelets having an average size of less than 90 nm in at least one direction.

11. The composite of claim 1 comprising from 10 to 140 weight parts of compatibilizer relative to 100 weight parts of exfoliated silicate platelets.

12. The composite of claim 1 wherein the polypropylene is a homopolymer.

13. The composite of claim 1 wherein the polypropylene is a co-polypropylene.

14. The composite of claim 13 wherein the co-polypropylene comprises from 0.1 to 10 mole % ethylene monomer content.

15. The composite of claim 1 wherein the polypropylene has a glass transition temperature of greater than −15° C.

16. The composite of claim 1 wherein the composite is essentially free from intercalating agent comprising onium functionality.

17. The composite of claim 1 having an impact strength of at least 0.3 joules and a modulus of at least 140,000 psi.

18. A packaged food comprising:
a package comprising the composite of claim 1; and
a food product packaged within the package, wherein the package has a temperature of at most 0° C.

19. The packaged food of claim 18 wherein the package comprises a tray comprising the composite of claim 1.

20. A packaging article comprising the composite of claim 1.
